(19) United States
(12) Patent Application Publication
(10) Pub. No.: US 2004/0203354 A1
(43) Pub. Date: Oct. 14, 2004

(54) Bluetooth remote access device

(76) Inventor: Lin Yue, San Jose, CA (US)

Correspondence Address: Corporate Patent Counsel, U.S. Philips Corporation, 580 White Plains Road, Tarrytown, NY, 10591, US

(21) Appl. No.: 10/186,097

(22) Filed: Jun. 29, 2002

(51) Int. Cl. H04B 5/00

(52) U.S. Cl. 455/41.1; 455/517

(57) ABSTRACT

A remote access device is configured to communicate with each Bluetooth device within a locale. When communication is desired between two Bluetooth devices within this locale, the remote access device allows the user to send commands and other information from the remote access device to each Bluetooth device to effect the initialization of the communication channel between the two devices. Using the remote access device, the user can make selections on each Bluetooth device, enter PINs as required, respond to confirmation requests, and the like. Because each Bluetooth device may be distant from the remote access device and distant from each other, the use of the remote access device allows a user to enable communications between the Bluetooth devices without traveling back and forth between physically separated Bluetooth devices.

### BACKGROUND OF THE INVENTION

1. Field of the Invention

This invention relates to the field of network communications, and in particular to a wireless device that facilitates Bluetooth connectivity between other devices.

2. Description of Related Art

Bluetooth is a wireless network standard that provides for the establishment of wireless networks in an ad hoc manner. Each Bluetooth-enabled device is configured to broadcast a short-range signal; when a new device is within range of the device, an initiation protocol commences to establish a communication channel between the devices. A class 1 Bluetooth device has a nominal range of 100 meters; a class 2 device, 10 meters; and a class 3 device, less than 10 meters. Most Bluetooth devices are expected to be class 2 devices with range of 10 meters.

Bluetooth supports both secure and non-secure communications between devices. Each Bluetooth device is identifiable by a unique 48-bit address, and includes a 128-bit private authentication key, an 8-128 bit private encryption key, and a 128-bit random number generator. The initiation protocol uses the device's unique address, a randomly generated number, and a secret PIN (Personal Identification Number) to facilitate a secure key-exchange over an as-yet-unsecured channel. The initiation process typically calls for the PIN to be manually entered into the Bluetooth device.

The Bluetooth initiation protocol is apparently based on a paradigm of two Bluetooth users coming within range of each other, or, a single user having direct access to both Bluetooth devices at the same time, such as a user of a Bluetooth-enabled PDA (Personal Data Assistant) arriving at a Bluetooth-enabled ATM (Automated Teller Machine). For example, the user arrives at the ATM and the Bluetooth initiation process commences based on the aforementioned detection of emanations from one or both of the Bluetooth-enabled devices. The user is prompted to enter the PIN on the PDA, for example, then prompted for a confirmation via a keypad on the ATM. Obviously, a user would not want to commence the transaction with the ATM unless the user were at the locale of the ATM.

Difficulties, or at least inconveniences, present themselves when Bluetooth devices are physically distant from each other, and a sole user desires to establish communications between these devices. Even though the devices may be within a common 10 meter range of each other, communications will not be established unless and until the user interacts with each device to effect the selection of each other, to enter one or more PINs as required, and so on. If the devices are not co-located, the user must travel back and forth between each device as the initiation protocol is effected. In like manner, difficulties or inconveniences present themselves after devices are “paired” for communication via the exchange of PINs. When an actual communication between the devices is desired, such as the transfer of a file from one device to another, the user may be required to configure or re-configure each device as a master or slave for this communication, and in some cases, must configure each device to effect a particular communication scheme or protocol.

### BRIEF SUMMARY OF THE INVENTION

It is an object of this invention to ease the task of initiating communications between two Bluetooth devices. It is a further object of this invention to provide a remote access device that facilitates communication between and among Bluetooth devices.

These objects and others are achieved by a remote access device that is configured to communicate with each Bluetooth device within a locale. When communication is desired between two Bluetooth devices within this locale, the remote access device allows the user to send commands and other information from the remote access device to each Bluetooth device to effect the initialization of the communication channel between the two devices. Using the remote access device, the user can make selections on each Bluetooth device, enter PINs as required, respond to confirmation requests, and the like. Because each Bluetooth device may be distant from the remote access device and distant from each other, the use of the remote access device allows a user to enable communications between the Bluetooth devices without traveling back and forth between physically separated Bluetooth devices.

### BRIEF DESCRIPTION OF THE DRAWINGS

The invention is explained in further detail, and by way of example, with reference to the accompanying drawings wherein:

FIG. 1 illustrates an example block diagram of a Bluetooth network in accordance with this invention.

FIG. 2 illustrates an example block diagram of a remote access device in accordance with this invention.

FIG. 3 illustrates an example block diagram of a Bluetooth device in accordance with this invention.

Throughout the drawings, the same reference numerals indicate similar or corresponding features or functions.

### DETAILED DESCRIPTION OF THE INVENTION

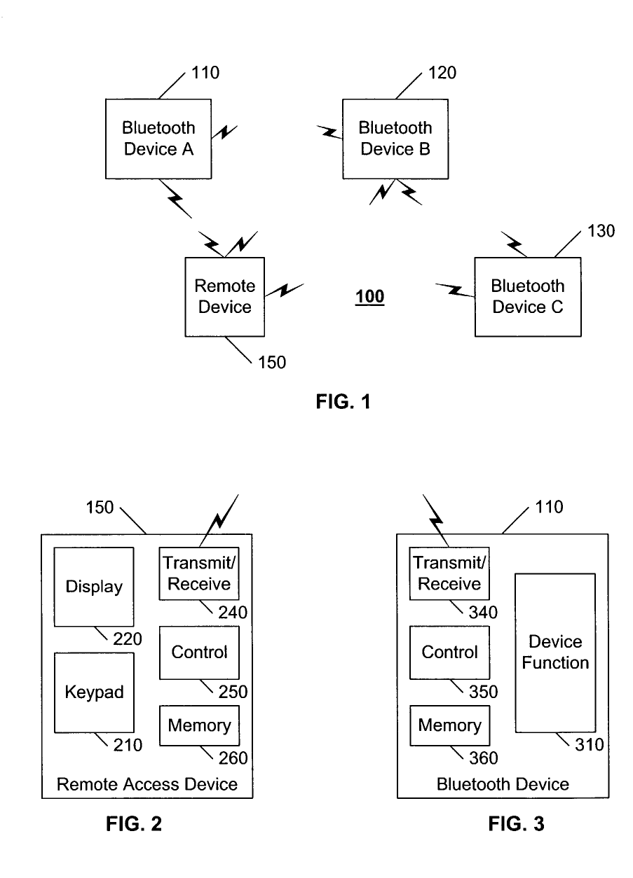

FIG. 1 illustrates an example block diagram of a Bluetooth network 100 in accordance with this invention. Illustrated in FIG. 1 are three Bluetooth devices 110, 120, 130, and a remote access device 150. As in a conventional Bluetooth network, the devices 110, 120, 130 are configured to communicate with each other, but only after an initialization protocol is effected to enable the communication. This initialization protocol may be as simple as selecting each other device from a list of devices displayed on each device, identifying which device is master and which is slave, and so on. Because communication security is becoming more prevalent, the more common initialization protocol will also include security parameters, such as the user's PIN. For ease of reference, the information communicated during the initialization process is hereinafter termed “initialization information”, the receipt of which effects an enabling of communications between the devices.

Generally, the initialization information is communicated each time a communication channel is to be established between two “paired” Bluetooth devices, although the principles of this invention may also be extended to facilitate pairings between Bluetooth devices, as discussed further below.

In accordance with this invention, the remote access device 150 is first configured to be able to communicate with each Bluetooth device 110-130. This may be effected in the conventional manner, by progressing from one Bluetooth device 110-130 to the next with the remote access device, and establishing a pairing between each Bluetooth device 110-130 and the remote access device 150, by entering a common PIN in each.

If a particular Bluetooth device lacks an input means for entering a PIN, the device is configured to have an internal PIN that is provided to the user. To establish a pairing between the remote access device 150 and this particular device the user merely enters the internal PIN into the remote device 150 while the remote device 150 is in the vicinity of this particular device.

If a particular Bluetooth device includes the ability to accept input information from a remote controller, such as an infrared controller, and if the remote device 150 also includes the means, such as an infrared transmitter, to provide this remote input information, the remote access device 150 can be establish the pairing with this particular Bluetooth device remotely.

After the remote access device 150 is paired to each of the Bluetooth devices 110, 120, 130, the remote access device 150 facilitates the initialization protocol for specific communications by allowing a user the opportunity to respond to requests for initialization information from each of the Bluetooth devices 110, 120, 130 via the remote access device 150. In the simple initialization protocol, for example, a Bluetooth device 110 may communicate a list of authorized/paired devices 120, 130 to the remote access device 150 for the user to select the appropriate device with which to effect the initialization process. Alternatively, as detailed further below, the remote access device 150 may be configured to display a list of authorized/paired devices from its internal memory, to allow a user to effect the initialization protocol between select devices by selecting devices from the list.

By allowing the user to initiate actions or respond to queries via the remote access device 150, the user can effect the initialization of communications between two Bluetooth devices without having to travel from one device to the other as the initialization protocol sequence progresses. A typical initialization process for establishing secure communications follows.

A user accesses the remote access device 150 and requests a list of available Bluetooth devices. These devices are generally the devices that have been previously paired with the device 150 and are currently in range of the device 150. From this list, the user selects a master device, such as device 110, and a slave device, such as device 130, and then initiates a “connect” sequence. If the devices 110 and 120 have previously been accessed by the device 150, the device 150 merely communicates the previously defined initialization information to each of the devices 110 and 130, or, the device 150 serves as a relay for the transfer of information between each device 110 and 130. Alternatively, the devices 110 and 130 may be configured to transfer information between each other upon receipt of the initialization information from the device 150. These and other protocols for effecting the initialization protocol between two devices 110, 130 via a remote device 150 that provides user commands to each of the devices 110, 130 will be evident to one of ordinary skill in the art in view of this disclosure.

In a preferred embodiment of this invention, the remote access device 150 is configured as a remote control device as well. The PCT International Publication WO 01/20572, “REMOTE CONTROL OF AN ELECTRONIC DEVICE THROUGH DOWNLOADING OF CONTROL INFORMATION IN A MOBILE STATION”, filed 10 Sep. 1999 for John R. Bell, and incorporated by reference herein, discloses a portable device that is configured to download control information for an other device, and thereafter uses this information to control the other device. Of particular note, this referenced publication discloses the remote control of Bluetooth devices via a programmable portable device. In the context of this invention, the control information may be preprogrammed into the remote device 150, or the control information may be communicated to the remote device 150 from the particular device 110, 120, 130, or from a remote source, such as an Internet site. In this manner, the remote access device 150 provides the functionality of a remote control device as well as a device that facilitates the enabling of communication between Bluetooth devices.

FIG. 2 illustrates an example block diagram of a remote access device 150 in accordance with this invention. The device 150 includes a keypad 210, or other input device, for accepting user directives, typically in response to messages that are displayed on a display 220, or other rendering device. For example, the input device 210 and/or rendering device 220 may be audio devices, video devices, or any other devices that effect input and output transactions with a user. The device 150 also includes a communicator 240 for communicating with Bluetooth devices, and a controller 250 that controls the operation of each of the devices 210, 220, and 240. A preferred embodiment of the remote access device 150 also includes a memory for storing initialization information and other material that facilitates the enabling of communications between external devices, such as devices 110, 120, 130 of FIG. 1.

FIG. 3 illustrates an example block diagram of a Bluetooth device 110 in accordance with this invention. The device 110 includes a functional element 310 that provides the primary functionality of the device 110, such as a television function, a PDA function, and so on. The device 110 also includes a communicator 340, a controller 350, and a memory 360 that facilitate the enabling of communication with other Bluetooth devices. In a conventional Bluetooth device, the interaction with the user to effect communication with other Bluetooth devices is effected locally. In accordance with this invention, the Bluetooth device 110 is configured to also effect the interaction with the user via the communicator 340. Messages are transmitted from the device 110, and responses or commands from the remote access device 150 of FIGS. 1 and 2 are received via the communicator 340 in the device 110 and the communicator 240 in the device 150. As noted above, in a preferred embodiment, the functional element 310 is also remotely controllable by the remote access device 150, via the communicators 240, 340.

The foregoing merely illustrates the principles of the invention. It will thus be appreciated that those skilled in the art will be able to devise various arrangements which, although not explicitly described or shown herein, embody the principles of the invention and are thus within its spirit and scope. For example, although the invention is presented above with a remote access device 150 that is separate and distinct from Bluetooth devices 110, 120, 130, the functionality of the remote access device 150 could be built into select Bluetooth devices, such as PDAs, palmtop and laptop computers, and so on. In like manner, the functionality of the remote access device 150 could also be incorporated into traditional stationary devices, such as televisions, personal computers, and so on, to allow a user to effect communication between devices from the Bluetooth device that is most convenient to the user at the time. These and other system configuration and optimization features will be evident to one of ordinary skill in the art in view of this disclosure, and are included within the scope of the following claims.

I claim:

1. A remote access device, comprising:
a communicator that is configured to provide communications between the remote access device and a plurality of Bluetooth devices,
a rendering device, operably coupled to the communicator, that is configured to render device messages from each of the plurality of Bluetooth devices, based on the communications between the remote access device and the plurality of Bluetooth devices,
an input device, operably coupled to the communicator, that is configured to convey user messages to each of the plurality of Bluetooth devices, and
a controller, operably coupled to the communicator, the rendering device, and the input device that is configured to facilitate an initiation of communications between a first Bluetooth device and a second Bluetooth device of the plurality of Bluetooth devices, based on the user messages that are conveyed to the first Bluetooth device and the second Bluetooth device by the remote access device.

2. The remote access device of claim 1, further comprising:
a memory that facilitates formation of the user messages via inputs to the input device.

3. The remote access device of claim 2, wherein
the memory is configured to contain initialization information corresponding to each of the first Bluetooth device and the second Bluetooth device.

4. The remote access device of claim 1, wherein
the remote access device is further configured to convey operating commands to one or more devices of the plurality of Bluetooth devices to effect control of the one or more devices, via inputs to the input device.

5. The remote access device of claim 1, wherein
the controller is configured to effect a rendering of one or more lists of the plurality of Bluetooth devices via the rendering device, and
at least one of the first Bluetooth device and second Bluetooth device is selected from the plurality of Bluetooth devices based on a user selection from the one or more lists, via the input device.

6. The remote access device of claim 1, wherein
the controller is further configured to relay messages between devices of the plurality of Bluetooth devices.

7. A Bluetooth device, comprising:
a communicator that is configured to provide communications between the Bluetooth device and a plurality of other Bluetooth devices, and
a controller that is configured to control the communications based on an initialization protocol between the Bluetooth device and each of the other Bluetooth devices; wherein
the controller is configured to allow a remote device of the plurality of other Bluetooth devices to act as a proxy for a further device of the plurality of other Bluetooth devices,
such that the initialization protocol is effected between the Bluetooth device and the further device via communications between the Bluetooth device and the remote device and communications between the remote device and the further device.

8. The Bluetooth device of claim 7, further comprising
a memory that is configured to store initialization information related to the further device, and
the controller is further configured to control the communications between the Bluetooth device and the further device based on the initialization information.

9. The Bluetooth device of claim 7, further comprising
a function element that effects a primary function of the Bluetooth device, and wherein
the controller is further configured to control the function element based on communications from the remote device.

10. A method of enabling communications between a first Bluetooth device and a second Bluetooth device, comprising:
communicating one or more first commands from a remote device to the first Bluetooth device, and
communicating one or more second commands from the remote device to the second Bluetooth device, wherein
the first commands include first initialization information for communicating with the second Bluetooth device, and
the second commands include second initialization information for communicating with the first Bluetooth device,
so that, after communicating the first and second commands from the remote device, communication is enabled between the first Bluetooth device and the second Bluetooth device.

11. The method of claim 10, further including:
rendering messages from each of the first Bluetooth device and the second Bluetooth device at the remote device, to facilitate communication of the first commands and the second commands.

12. The method of claim 11, wherein
the messages include one or more lists of Bluetooth devices, and
the first commands and second commands are communicated in response to a selection of the first Bluetooth device and the second Bluetooth device from the one or more lists of Bluetooth devices.

13. The method of claim 10, wherein
at least a part of the first and second initialization information is stored at the remote device.
